(19) United States
(12) Patent Application Publication
(10) Pub. No.: US 2006/0225141 A1
(43) Pub. Date: Oct. 5, 2006

(54) Unauthorized access searching method and device

(75) Inventor: Manabu Fujimori, Kawasaki (JP)

Correspondence Address: BINGHAM MCCUTCHEN LLP, 3000 K STREET, NW, BOX IP, WASHINGTON, DC, 20007, US

(73) Assignee: Fujitsu Limited

(21) Appl. No.: 11/280,340

(22) Filed: Nov. 17, 2005

(30) Foreign Application Priority Data
Mar. 30, 2005 (JP) 2005-097705

(51) Int. Cl. H04N 7/16; G06F 17/30; G06F 7/04; G06K 9/00; H03M 1/68; H04K 1/00; H04L 9/00; H04L 9/32

(52) U.S. Cl. 726/29

(57) ABSTRACT

In a method and device for searching (or chasing) an unauthorized access, it is determined whether or not the device itself is designated as a searching device at an endpoint of a subnet accommodating an unauthorized access terminal; and if the device itself is not designated as the searching device at the endpoint and when an unauthorized access that has been regarded by the searching device at the endpoint as not having an address spoofed is detected or a notification of the unauthorized access is received, a search request including an address of the unauthorized access terminal is issued towards the searching device at the endpoint. Also, if the device itself is designated as the searching device at the endpoint and when the search request is received, countermeasure processing is performed to a switch in a lower layer accommodating the unauthorized access terminal included in the search request. If the device itself is not designated as the endpoint and when the search request is received, the search request to a next hop searching device is issued. Alternatively, the searching device which has initiated issuing the search request performs the search request sequentially to a searching device of an intermediate hop between the searching devices on both ends until the searching device at the endpoint is verified.

### BACKGROUND OF THE INVENTION

1. Field of the Invention

The present invention relates to an unauthorized access searching method and device, and in particular to a method and device for performing a search (Security Chase) of an unauthorized access such as a DoS attack on a network system from a malicious user.

2. Description of the Related Art

A method called iTraceback has been known as countermeasures taken against an unauthorized access. In this method, all of the packets are stored, in which when a problem arises, the stored packet information is examined manually and an unauthorized access is detected.

As a prior art example of such a method, there are a transmission source tracing apparatus and program in which even while a victim apparatus is delivered with an attack of service interference by an attacker apparatus via each of routers, a requester side tracing apparatus transmits a trace request message to a router apparatus having a responder side tracing apparatus, and the responder side tracing apparatus conducts a tracing system selected from one or more kinds of passive tracing systems and one or more kinds of active tracing systems (see e.g. patent document 1).

Also, there are a defensive method, an apparatus against denial-of-service attack and a computer program thererfor in which in order to defend a computer of a person to be attacked, shields distributed with a variable level number are located. The shields analyze a packet associated with the computer of the person to be attacked, narrow down the band of suspicious traffic by an examination and detect the attack. When the attack is detected, the shields transfer a program of a probe toward the upstream of the attack, so that when the packet of the attack is found, the probe discards the packet and further transfers the program of the probe toward the upstream side (see e.g. patent document 2).

Moreover, there are a method and system for tracking electronic data and a recording medium in which a data tracking system is constituted by providing a plurality of data repeaters chain-connected on a network and a managing system equipped with a means for bidirectionally communicating with the respective data repeaters. Each data repeater analyzes the identifier of a lower layer for carrying electronic data on a network and based on this analyzed result, the preceding device having passed the electronic data is specified. When the specified device is provided with a function equal with that of the present device, the further preceding another device having passed the electronic data is specified. Besides, the analyzed result of the present device is reported to the managing system together with predetermined identification information. Based on the information reported from the respective data repeaters, the managing system specifies the distribution route of the relevant electronic data (see e.g. patent document 3).

[Patent document 1] Japanese Patent Application Laid-open No. 2004-274481

[Patent document 2] Japanese Patent Application Laid-open No. 2000-124952

[Patent document 3] Japanese Patent Application Laid-open No. 2003-283571

In the above-mentioned prior art technologies, it has been required to store all of the packet information, having been disadvantageous that a large memory capacity is required and a packet of an erroneous address is concurrently stored.

### SUMMARY OF THE INVENTION

It is accordingly an object of the present invention to provide a method and device for performing a search or chase of an unauthorized access with a simple arrangement without requiring a large memory capacity.

In order to achieve the above-mentioned object, an unauthorized access searching method or device according to the present invention comprises the steps or means of determining whether or not a device itself is designated as a searching device at an endpoint of a subnet accommodating an unauthorized access terminal; detecting an unauthorized access that has been regarded by the searching device at the endpoint as not having an address spoofed, or receiving a notification of the unauthorized access if the device itself is not designated as the searching device at the endpoint; and issuing a search request including an address of the unauthorized access terminal towards the searching device at the endpoint when the unauthorized access is detected or the notification is received.

Namely, in the present invention, a packet whose address is spoofed is discarded in a searching device at the endpoint (access end) of a subnet accommodating the user terminal of an unauthorized access, as conventionally known.

Therefore, a searching device other than the endpoint issues a search request when a packet of the unauthorized access that has been regarded by the searching device at the endpoint as not having an address spoofed is detected or the notification of the unauthorized access is received. Since the search request includes the address of the unauthorized access terminal, the search request is to be issued toward a searching device corresponding to the address, i.e. at the endpoint located on the subnet accommodating the user terminal of the unauthorized access.

Therefore, the searching device having received the search request can process countermeasures to a switch in a lower layer, e.g. an L2 switch, accommodating the unauthorized access terminal.

Thus, the search of the terminal having performed the unauthorized access can be executed. However, in some cases as will be described below, other searching devices or devices other than the searching device, e.g. an L3 switch, exist between the device making the search request and the device at the endpoint. This will now be described. It is to be noted that the unauthorized access packet can pass through a plurality of searching devices because some of the searching devices are not provided with a function of detecting the unauthorized access, e.g. a firewall.

Firstly, upon receiving the search request, the searching device that is not designated as the endpoint issues the search request to a searching device of a next hop. Therefore, if the searching device having received this search request is not designated as the endpoint, the issue of the search request is sequentially transferred hop-by-hop.

Also, besides the case of consecutively changing the device issuing the search request hop-by-hop by the searching device having received the search request, the searching device which has initiated the search request may be made to perform the search request sequentially to a searching device of an intermediate hop until the searching device at the endpoint is verified.

Also, since the device that is not the searching device, e.g. the L3 switch, may exist between the searching devices as mentioned above, whether or not the next hop, as a first next hop, is a searching device provided with a searching function may be verified before issuing the search request to the searching device of the first next hop, so that whether or not a subsequent next hop is a searching device may be further verified without stopping the search request there if the first next hop is not a searching device, e.g. when it is the L3 switch as mentioned above.

Thus, it is made possible to transmit the search request to the last searching device at the endpoint.

Also, in some cases, not a single but a plurality of searching devices having detected the above-mentioned unauthorized access may exist. This is caused by providing protection stages for an unauthorized access detection for each of the searching devices. Since the packet related to the unauthorized packet passes through the searching device until the protection stages are passed, each of the searching devices may detect the unauthorized access in some cases.

In such a case, search requests related to the same unauthorized access may be received, so that a detection completion of the unauthorized access may be notified to the searching device that has issued the search request.

Thus, it is made possible to reduce needless processing after having issued the search request.

It is to be noted that the search request may be issued after having executed an authentication procedure for the next hop when an existence of the next hop is verified.

The countermeasure processing may be performed by setting a filter by a telnet.

Moreover, the filter setting may be released after a lapse of a fixed time after the filter setting.

According to the present invention, it is made possible to detect an unauthorized access that has been regarded by an endpoint searching device as not having an address spoofed, to specify a user terminal of such an unauthorized access, and to take countermeasures. Therefore, pooling redundant information becomes unnecessary, enabling a search of an unauthorized access with an extremely simple arrangement to be realized.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an arrangement of an unauthorized access searching device according to the present invention;

FIG. 2 is a block diagram showing a network arrangement when an unauthorized access is performed by spoofing a source IP address;

FIG. 3 is a block diagram showing a network arrangement as an example of detecting an unauthorized access and taking countermeasures against the unauthorized access with a searching device adjacent to an L2 switch;

FIG. 4 is a sequence block diagram showing a countermeasure processing example from a searching device to an L2 switch;

FIG. 5 is a block diagram showing a network arrangement for executing a hop-by-hop search (detection by a remote searching device) according to the present invention;

FIG. 6 is a sequence diagram showing a modification of the hop-by-hop search example shown in FIG. 5;

FIG. 7 is a block diagram showing a network arrangement executing an endpoint search example (detection by a remote searching device) according to the present invention;

FIG. 8 is a sequence diagram of the endpoint search example shown in FIG. 7;

FIG. 9 is a block diagram showing a network arrangement executing a neighborhood search example (detection by a remote searching device) according to the present invention;

FIG. 10 is a sequence diagram of the neighborhood search example shown in FIG. 9;

FIG. 11 is a block diagram showing a network arrangement executing an example of an unauthorized access detection/search by a plurality of searching devices according to the present invention;

FIG. 12 is a sequence diagram of the detection/search example shown in FIG. 11;

FIG. 13 is a sequence diagram when the sequence example of the detection/search example shown in FIG. 12 is applied to the endpoint search example; and

FIG. 14 is a sequence diagram when a timeout occurs in each of the above-mentioned sequence examples.

### DESCRIPTION OF THE EMBODIMENTS

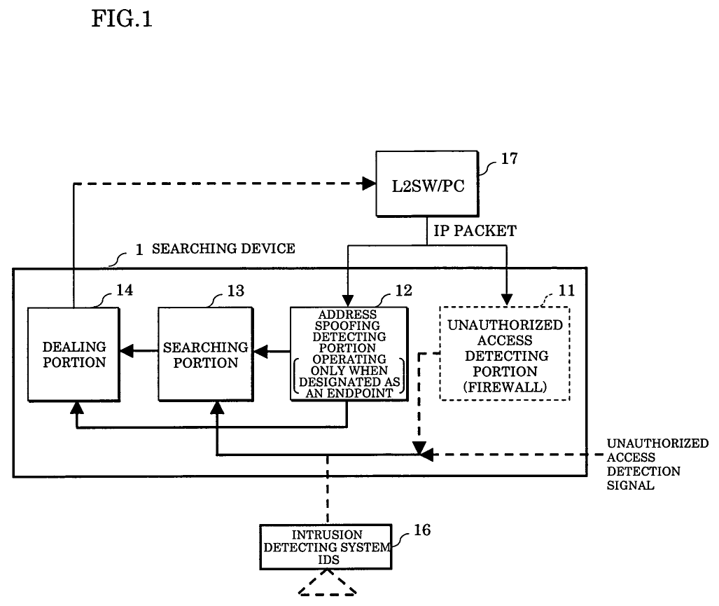

FIG. 1 shows an arrangement embodiment of a device for realizing an unauthorized access searching method according to the present invention. In FIG. 1, a searching device 1 is provided with an unauthorized access detecting portion 11, an address spoofing detecting portion 12, a searching portion 13 connected to the detecting portions 11 and 12, and a dealing portion 14 connected to the address spoofing detecting portion 12 and the searching portion 13. Also, the searching portion 13 is connected to an external intrusion detecting system (IDS) 16. The detecting portions 11 and 12 are connected to an L2 switch or a terminal (PC) 17 so that an IP packet is inputted therefrom. The L2 switch or the terminal (PC) 17 is connected to the dealing portion 14 so as to receive countermeasures therefrom, i.e. to be dealt with by the dealing portion 14.

The unauthorized access detecting portion 11 is e.g. a firewall that detects mainly a DoS attack such as an IP spoofing attack, a SYN Flood attack, a UDP Bomb attack and a LAND attack. Therefore, the unauthorized access detecting portion 11 need not necessarily be provided within the searching device 1 and may receive an unauthorized access detection signal from outside, so that it is shown by a dotted line. Also, the unauthorized access detecting portion 11 may detect worms and viruses. However, as for the worms and viruses, the intrusion detecting system 16 plays the role in many cases.

Also, the address spoofing detecting portion 12 has functions such as detection of whether or not a source IP address is accommodated within its own subnet and detection of routing information of a source address, and is preset to operate only in the searching device at an endpoint without operating in other searching devices.

Also, the searching portion 13 is provided with functions such as a hop-by-hop search, an endpoint search and a neighborhood search. Moreover, the dealing portion 14 executes countermeasures such as a TRAP issue, a syslog issue, a management server notification, a mail notification and an L2 switch filtering instructions.

It is to be noted that although not shown in FIG. 1, the searching device 1 is provided with a TCP/IP protocol stack, and performs a TCP header check, an UDP header check and the like.

Various kinds of functions of a searching device according to the present invention will now be described based on various unauthorized access examples.

Unauthorized Access Example with Spoofed Source IP Address:

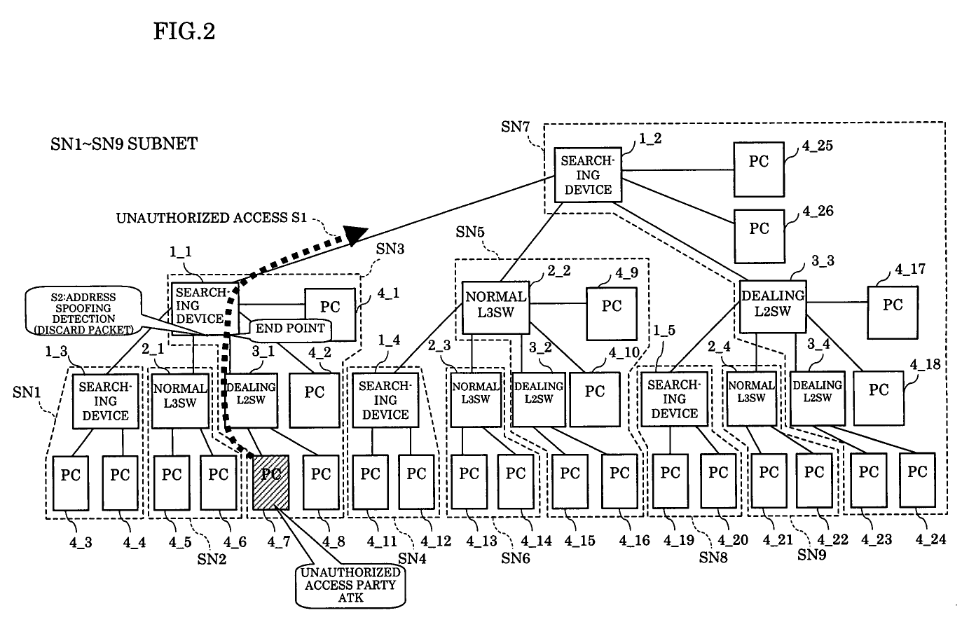

Such an unauthorized access example is shown in FIG. 2 where a network composed of searching devices 1_1-1_5 (hereinafter, occasionally represented by a reference numeral “1”), normal L3 switches (L3SW) 2_1-2_4 (hereinafter, occasionally represented by a reference numeral “2”), L2 switches (L2SW) 3_1-3_4 (hereinafter, occasionally represented by a reference numeral “3”), and user terminals (PC) 4_1-4_26 (hereinafter, occasionally represented by a reference numeral “4”). It is to be noted that the searching devices 1 correspond to the L3 switches 2 with a searching function added thereto, and that some of the searching devices 1 are not provided with the unauthorized access detecting portion 11.

Also, as shown in FIG. 2, the searching devices 1_3, 1_1, 1_4, 1_2 and 1_5 respectively form subnets SN1, SN3, SN4, SN7 and SN8, and the L3 switches 2_1, 2_2, 2_3 and 2_4 respectively form subnets SN2, SN5, SN6 and SN9.

In this network, when e.g. an unauthorized access party (attacker) ATK transmits a packet whose source IP address is spoofed from the PC 4_7 through the L2 switch 3_1 to the searching device 1_1, the searching device 1_1 that forms an endpoint of the subnet SN3 performs, for the unauthorized access (at step S1), an address spoofing detection with the address spoofing detecting portion 12 (at step S2). The dealing portion 14 having received the notification discards the unauthorized access packet.

It is to be noted that the address spoofed packet cannot be detected if it is from its own subnet SN3, where it is generally detected in combination with a MAC address. Such a processing is conventionally known as address spoofing detection processing.

Example of Detecting and Dealing with Unauthorized Access by Searching Device at Endpoint:

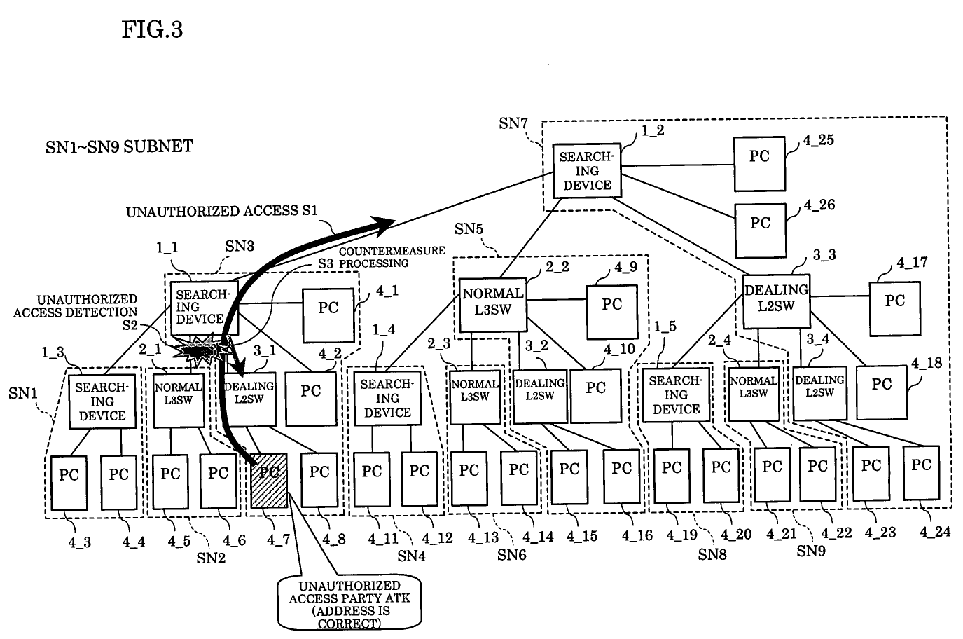

Such an example is shown in FIG. 3. While in this example, an unauthorized access (at step S1) is transmitted from the PC 4_7 hatched, in the same way as in the example shown in FIG. 2 through the L2 switch 3_1 to the searching device 1_1, it is not an unauthorized access of the above-mentioned address spoofing but an unauthorized access such as a DoS attack. Therefore, the packet is detected this time not by the address spoofing detecting portion 12 but by the unauthorized access detecting portion 11 (at step S2).

The dealing portion 14, having been notified from the unauthorized access detecting portion 11 that the unauthorized access has been detected, performs a countermeasure processing to the L2 switch 3_1 accommodating the PC 4_7.

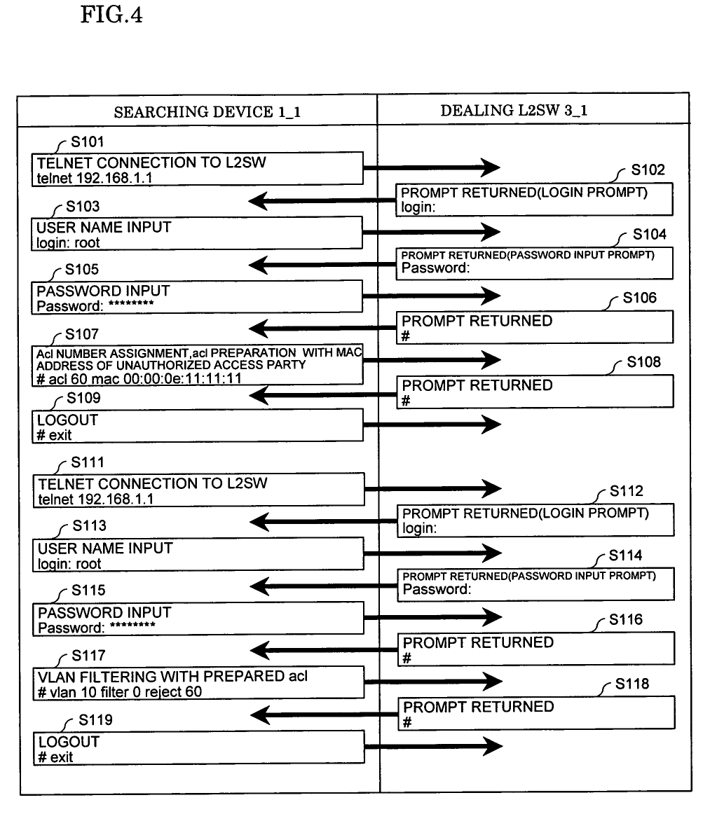

An example of the countermeasure processing in this case is shown in FIG. 4. It is to be noted that a conventionally known telnet system can be used for this countermeasure processing. Namely, the searching device 1_1 establishes a telnet connection to the L2 switch 3_1 (at step S101). In response thereto, a prompt is returned from the L2 switch 3_1 (at step S102) so that a user name is inputted (at step S103). Also in response thereto, a prompt is returned (at step S104), so that a password is further inputted (at step S105). At a time when a prompt in response thereto is returned (at step S106), an ad number is assigned, an ad is prepared with a MAC address of the unauthorized access party (at step S107), and transmitted to the L2 switch 3_1. By having a prompt at this time returned (at step S108), the searching device 1_1 logs out (at step S109).

Thereafter at steps S111-S116, the same procedures as in the above-mentioned steps S101-S106 are repeated. Then at step 117, filtering setting is performed in the VLAN with the ad prepared, for which a prompt is returned from the L2 switch 3_1 (at step S118), and the searching device 1_1 logs out (at step 119).

It is to be noted that after having thus performed the filtering setting as the countermeasure processing, a processing for releasing the filter setting will be performed by the switching device 1_1 to the L2 switch 3_1 at a time when e.g. a fixed time elapses.

Hop-by-Hop Search Example (Detection by Remote Searching Device):

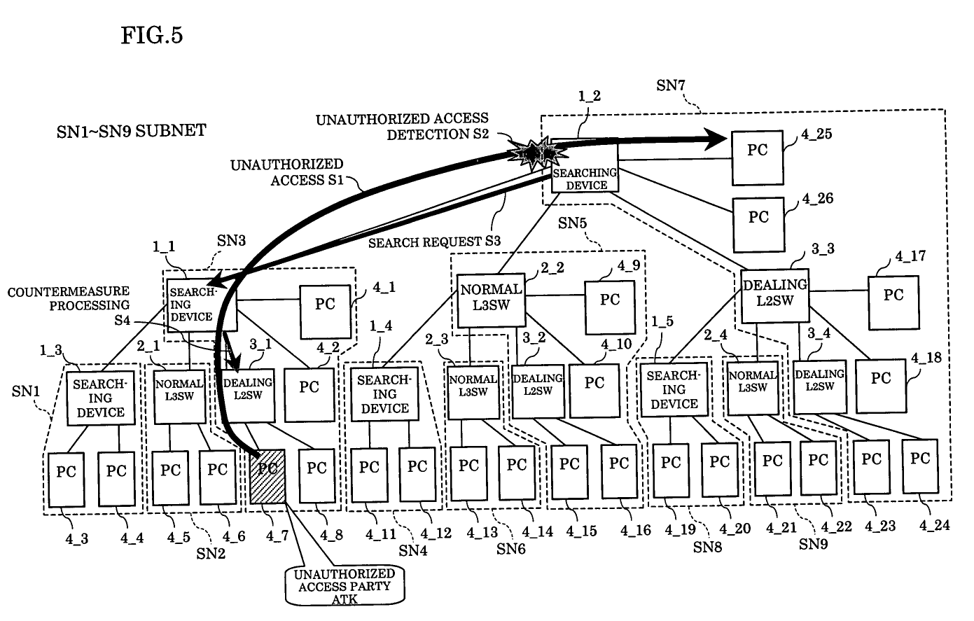

Such an example is shown in FIG. 5 which handles a case where the unauthorized access detecting portion 11 is not provided in the searching device 1_1 in the same network arrangement as the examples shown in FIGS. 2 and 3 (since the searching device 1_1 is the endpoint, it has the address spoofing detecting portion 12). In such a case, the unauthorized access (at step S1) from the PC 4_7 through the L2 switch 3_1 passes through the searching device 1_1 and is transmitted to the searching device 1_2 at the next stage. Since the searching device 1_2 is provided with the unauthorized access detecting portion 11, the unauthorized access detecting portion 11 performs the unauthorized access detection (at step S2). At this time, the address spoofing detecting portion 12 determines that the unauthorized access packet is not an attack from its own subnet SN7, so that the searching device 1_2 performs a searching request including an IP address of the terminal 4_7 of the unauthorized access party ATK to the searching device 1_1 (at step S3).

The searching device 1_1 having received such a request (at step S3) performs the countermeasure processing (at step S4) to the L2 switch 3 accommodating the PC 4_7 of the unauthorized access party ATK in the same way as the example of FIG. 3. The countermeasure processing is performed by e.g. filtering setting as shown in FIG. 4. Such a countermeasure processing will be released after a fixed time from the searching device 1_1 to the L2 switch 3_1 as in the example of FIG. 3.

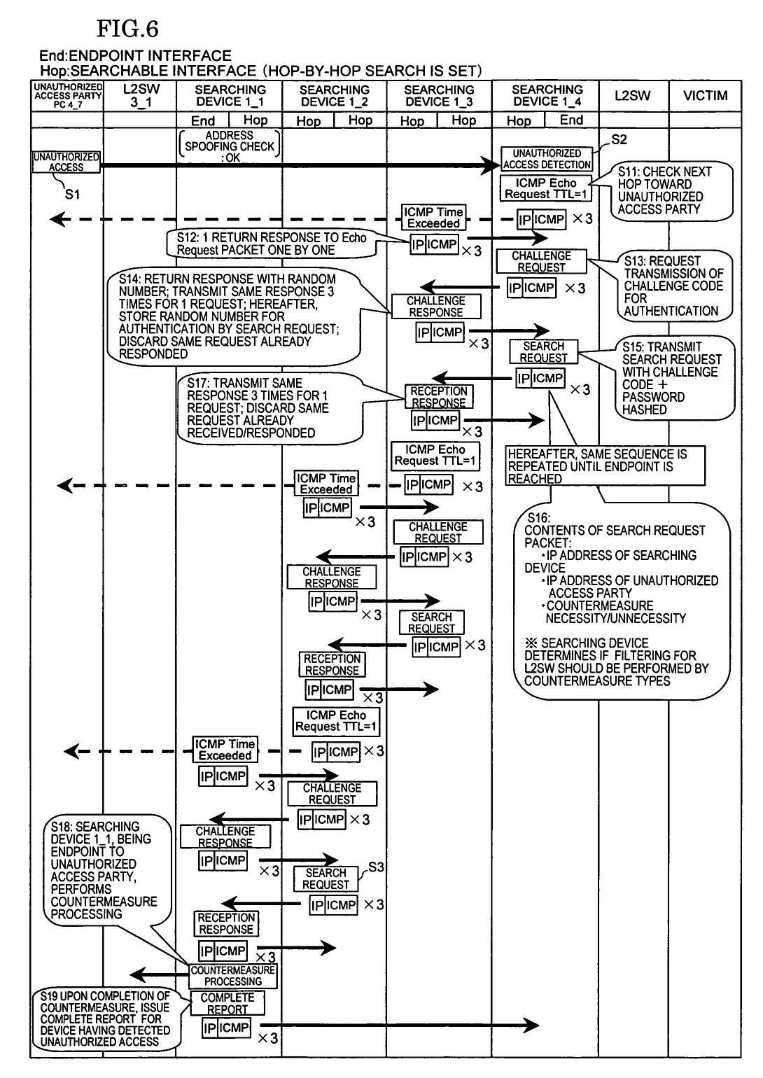

A modification of such a hop-by-hop search example shown in FIG. 5 is shown by a sequence of FIG. 6. While this sequence example shows an operation procedure for a hop-by-hop search using four searching devices 1_1-1_4, the basic idea is the same as that of the example of FIG. 5.

Namely, when the unauthorized access (at step S1) from the PC 4_7 of the unauthorized access party is transmitted to the searching device 1_1 through the L2 switch 3_1, the searching device 1_1 transmits the unauthorized access to the next searching device 1_2 in the same way as the example of FIG. 5. Supposing that the searching device 1_2 is not provided with the unauthorized access detecting portion 11 in this example, the unauthorized access packet is further transferred to the next searching device 1_3. Supposing that the searching device 1_3 is also not provided with the unauthorized access detecting portion 11, the unauthorized access packet is further transferred to the searching device 1_4. In the searching device 1_4, the unauthorized access detecting portion 11 performs the unauthorized access detection (at step S2).

It is to be noted that while the address spoofing detecting portion 12 performs the address spoofing detection in the searching device 1_1, the address is treated as a correct one in this example in the same way as in FIG. 5. Since the searching devices 1_2-1_4 are not the endpoint, the address spoofing detecting portion 12 is set up to be inoperable, so that the address spoofing detection is not performed. To this effect, “End” and “Hop” are shown at the top of FIG. 6.

In the searching device 1_4, based on the unauthorized access detection (at step S2), the searching portion 13 executes the hop-by-hop search as follows:

Step S11: The searching portion 13 checks if a next hop exists, toward the unauthorized access party. This is performed by using an ICMP message as shown by the following Table 1. In this case, in order to verify the existence of the next hop, the ICMP message where a TTL (Time-to-live) set to 1 is transmitted to the searching device 1_3 upon an Echo Request.

TABLE 1
ICMP MESSAGE

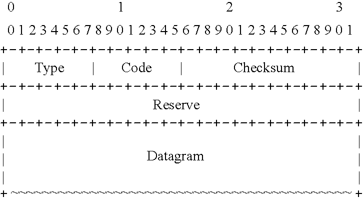

| Type: | 127 = Unauthorized Access Search Message |
|---|---|
| Code: | 0 |
| Checksum: | Checksum assumes 1's complement of 16 bits for total of |
| | 1's compliment of ICMP message beginning with ICMP |
| | Type; During checksum calculation, Checksumfield is made |
| | 0 |

Step S12: In the searching device 1_3, upon receiving an ICMP echo request from the searching device 1_4, one response packet per packet of an echo request is returned. This is executed three times as a protective operation.

Step S13: The searching device 1_4 having received an ICMP response message from the searching device 1_3 has verified the existence of the next hop, so that the searching device 1_4 requests the searching device 1_3 to transmit a challenge code for authentication. An example of a message thus exchanged preliminarily between the searching devices for encoding passwords at the time of the authentication is shown in the following Table 2.

TABLE 2
MSSAGE PRELIMINARILY EXCHANGED FOR PERFORMING
PASSWORD ENCODING
UPON AUTHENTICATION BETWEEN SEARCHING DEVICES

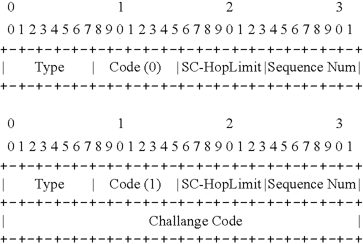

| | |
|---|---|
| Type: | 1 = Authentication Message |
| Code: | 0 = Authentication Request |
| | 1 = Authentication Reply |
| SC-HopLimit: | HopLimit as searching device; Used for |
| | determination to interrupt search halfway when |
| | search path is inordinately long; Search is enabled |
| | up to 3 hops from device having detected |
| | unauthorized access and initiated search |
| Sequence Number: | Number for uniquely identifying Challenge Request/ |
| | Response packet |
| Challenge-Code: | Searching device receiving request fills in |
| | Challenge-Code for authentication; Transmit Reply |
| | with all 0 when receiving side's setting is |
| | authenticationless |

Step S14: The searching device 1_3 having received such a challenge request from the searching device 1_4 also uses the message shown in Table 2, puts a random number in this message and returns a response (challenge response) to the searching device 1_4. In this case, the searching device 1_3 transmits the same response three times for a single request. Thereafter, in order to perform authentication for a search request, the random number is stored. It is to be noted that the same request that has been already responded is discarded. This will be described later.

Step S15: The searching device 1_4 having received the challenge-response, issues a search request by performing a hash calculation to the challenge code+password in a message shown in the following Table 3.

TABLE 3
MESSAGE FOR PERFORMING SEARCHING
REQUEST/REPLY BETWEEN SEARCHING DEVICES

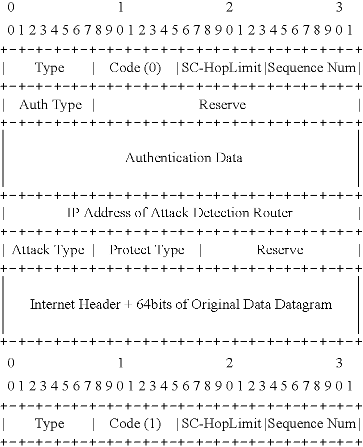

| | |
|---|---|
| Type: | 2 = Search Request and Reply Message |
| Code: | 0 = Search Request |
| | 1 = Search Reception Reply |
| SC-HopLimit: | HopLimit as searching device; Used for determination to |
| | interrupt search halfway when search path is inordinately |
| | long; Search is enabled up to 3 hops from device having |
| | detected unauthorized access and initiated search |

Sequence Number:

| | |
|---|---|
| | Number for uniquely identifying Search |
| | Request/Response PACKET |
| Auth Type: | 0 = Authenticationless |
| | 1 = Plain text (up to 8 characters) |
| | 2 = Encrypted password |

Authentication Data:

1. Authenticationless
Fill with all zero
2. Plain text password
Allowed up to 8 characters; Fill in gaps with zero
3. Encrypted password
Input MD5 of password and challenge

IP Address of Attack Detection Router:
IP address of device having detected unauthorized access and initiated
search; Message is sent to this device upon search completion, search
discontinuation, etc.

| | |
|---|---|
| Attack Type: | Types of unauthorized access numbered |
| Protect Type: | Flag for distinguishing countermeasures |
| | Notification from firewall is desired |
| | For example: |
| | 0 = Countermeasure by L2SW is performed |
| | 1 = Countermeasure by L2SW is not performed |

Internet Header + 64bits of Original Data Datagram:
Head portion of unauthorized access packet; Device having received
search request determines if the device itself is endpoint from IP address
of unauthorized access party

Step S16: Contents of the search request packet in this case are an IP address of the searching device, an IP address of the unauthorized access party and countermeasure necessity/unnecessity.
Step S17: For a single search request from the searching device 1_4, the searching device 1_3 transmits the same acceptance response three times to the searching device 1_4. Also, the searching device 1_3 discards a response already having been received/responded.

Thus, the searching device 1_3 having received the search request from the searching device 1_4 further executes for the searching device 1_2 that is the next hop the same procedure as that performed by the searching device 1_4 for the searching device 1_3. This is completely the same in the relationship between the searching device 1_2 and the searching device 1_1.

Step S18: In the searching device 1_1 thus having received the search request from the searching device 1_2 and performed the acceptance response, the searching portion 13 recognizes that the searching device 1_1 itself is predesignated as an endpoint, so that after verifying that the endpoint is of a subnet where the IP address (see the message in the following Table 4) of the unauthorized access terminal 4_7 included in the search request belongs, the searching device 1_1 takes the countermeasure.

Namely, as shown at the top of FIG. 6, the searching devices 1_1 and 1_4 have the endpoint interface “End” and the searchable interface “Hop”, and the intermediate searching devices 1_2 and 1_3 are provided with only the searchable interface “Hop”.

It is to be noted that the above-mentioned countermeasure processing is executed with the procedure as shown in FIG. 4.

Step S19:

When the countermeasure processing is completed, the searching device 1_1 issues a complete report to the searching device 1_4 having detected the unauthorized access. An example of a message used in this case is shown in the following Table 4.

TABLE 4
MESSAGE FOR PERFORMING STATUS NOTIFICATION OF
SEARCH/COUNTERMEASURE PROCESSING BETWEEN
SEARCHING DEVICES
(ISSUED BY DEVICE HAVING RECEIVED SEARCH REQUEST)

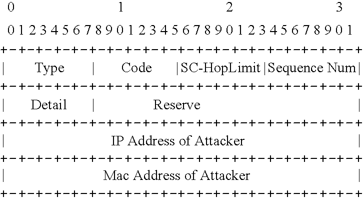

| | |
|---|---|
| Type: | 3 = Report Message |
| Code: | 0 = Search Complete Report |
| | (Notified upon arrival at endpoint) |
| | 1 = Deal Complete Report |
| | (Countermeasure Complete Report) |
| | 2 = Search Halt Report |
| | (Search failure notification) |
| | 3 = Deal Halt Report |
| | (Countermeasure failure notification) |
| SC-HopLimit: | HopLimit as searching device; Used for determination to |
| | interrupt search halfway when search path is inordinately |
| | long; Search is enabled up to 3 hops from device having |
| | detected unauthorized access and initiated search |

Sequence Number:

| | |
|---|---|
| | Number for uniquely identifying notification packet |
| Detail: | Categorize result of search/countermeasure |
| | 0 = Normal (Made 0 upon Complete Report) |
| | 1 = Countermeasure for L2SW unnecessary |
| | 2 = No response from next hop |
| | 3 = Search interruption due to hop count limit of IP-TTL |
| | 4 = Search interruption due to hop count limit of |
| | SC-HopLimit |
| | 5 = Countermeasure disabled due to absence of L2SW |
| | 6 = Countermeasure failure due to telnet connection |
| | failure to L2SW |
| | 7 = Countermeasure failure due to ACL number upper |
| | limit of L2SW |
| | 8 = Countermeasure failure due to filter number upper |
| | limit of L2SW |
| | 9 = Failure due to absence of concerned endpoint |
| | interface |

IP Address of Attacker:

IP address of unauthorized access party

MAC Address of Attacker:

MAC address of unauthorized access party; Notified only
when search is completed

up to endpoint

Assumes all 0 when search is interrupted

It is to be noted that at steps S18 and S19, by checking the contents of the search request, the searching device 1_1 executes countermeasure processing when it is the unauthorized access requiring the countermeasure processing to the L2 switch 3_1, and transmits only the search complete report when “countermeasure necessity/unnecessity” indicates that the countermeasure is unnecessary.

Endpoint Search Example (Detection by Remote Searching Device):

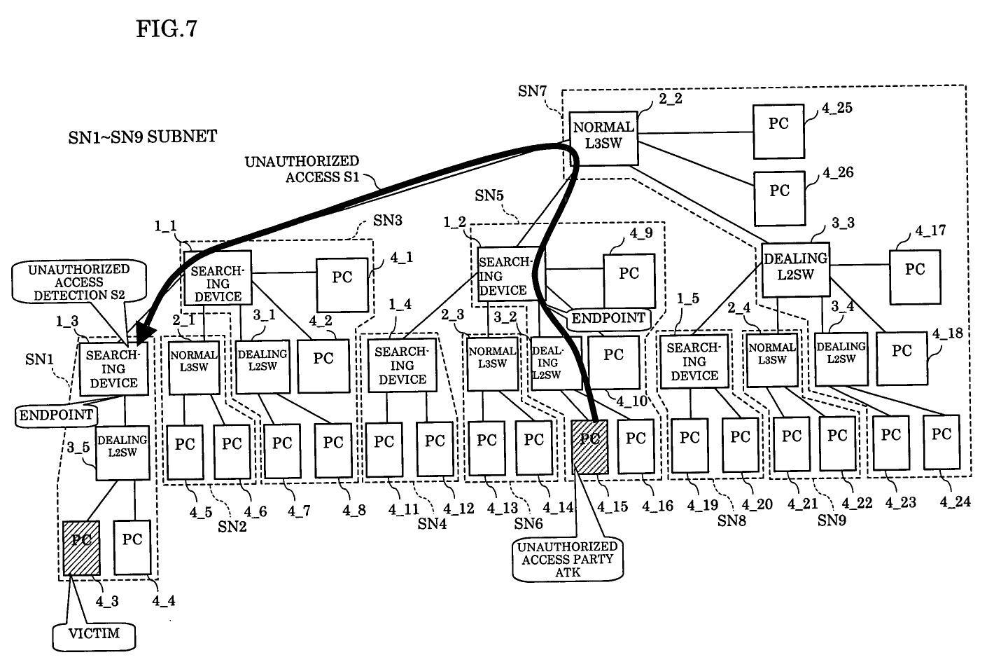

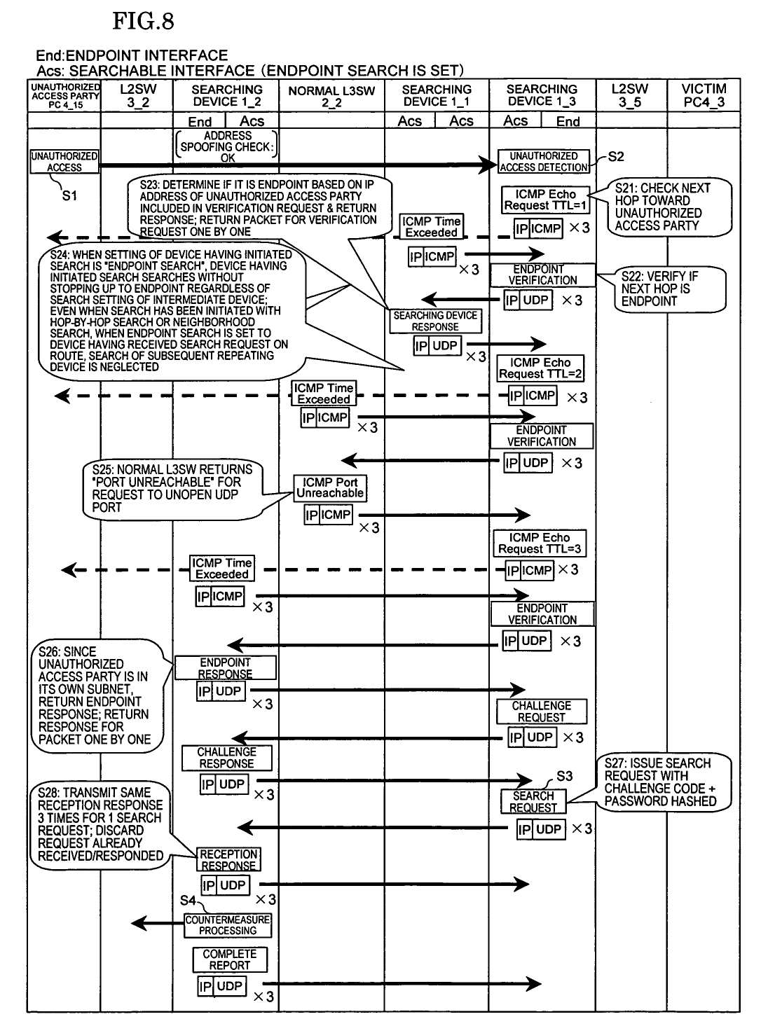

The network arrangement example is shown in FIG. 7. This example is different from the above-mentioned example in that the L2 switch 3_5 is provided in the subnet SN1 of the searching device 1_3. The search example of FIG. 7 corresponds to the sequence diagram shown in FIG. 8, so that operation procedures of this search example will now be described referring to FIGS. 7 and 8.

Firstly in this example, as shown in FIGS. 7 and 8, the unauthorized access (at step S1) passes through a route from the unauthorized access party's PC 4_15, the L2 switch 3_2, the searching device 1_2, the L3 switch 2_2 and the searching device 1_1, and the unauthorized access detection (at step S2) is performed by the searching device 1_3. Namely, this indicates that in the intermediate devices, the unauthorized access detection was not performed and the verification result of the address spoofing was “OK” at the searching device 1_2 at the endpoint. Also, the searching devices are set to endpoint search (Acs).

Step S21: This step is for checking if a next hop exists toward the unauthorized access party in the same way as step S11 shown in FIG. 6.

Step S22: While the existence of the next hop is verified as a result of the above-mentioned step S21, the procedure for the verifying if the next hop is an endpoint is further executed. An example of an UDP message used in this case is shown in the following Table 5.

TABLE 5
VOP MESSAGE

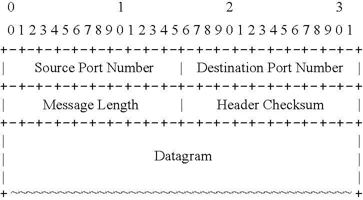

Source Port Number, Destination Port Number
NO. xxx (Unauthorized access search protocol)

It is to be noted that a message shown in the following Table 6 is stored in “Datagram” of the UDP message.

TABLE 6
MESSAGE FOR VERIFYING IF PARTNER IS SEARCHING DEVICE
(IF PARTNER IS ENDPOINT)

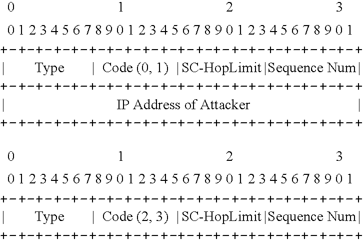

| | |
|---|---|
| Type: | 0 = Information Request and Reply Message |
| | (Unauthorized access search information Request/Reply |
| | message) |
| Code: | 0 = Searching Device Verification Request |
| | (Searching device verification) |
| | 1 = Endpoint Verification Request |
| | (Endpoint verification) |
| | 2 = Searching Device Verification Reply |
| | (Searching device response) |
| | 3 = Endpoint Verification Reply |
| | (Endpoint response) |
| SC-HopLimit | HopLimit as searching device; Used for determination to |
| | interrupt search halfway when search path is inordinately |
| | long; Search is enabled up to 3 hops from device having |
| | detected unauthorized access and initiated search |

Sequence Number:

Number for uniquely identifying mounted device
verification packet

IP Address of Attacker:

IP address of unauthorized access party; Device having
received endpoint verification request determines if it is
endpoint based on this IP address

Step S23: The searching device 1_1 having received an inquiry about whether or not it is an endpoint from the searching device 1_3 determines whether or not the searching device 1_1 itself is an endpoint based on an IP address of the unauthorized access party included in the verification request and makes a response. In this case, a single packet is returned for one verification request. This is also performed with the above-mentioned message shown in Table 6.
Step S24: Thus, the setting of the searching device 1_3 which has started the searching is “Endpoint search”, so that the search is started from the device which has started the endpoint search to the endpoint without stopping regardless of the search setting of the intermediate devices. Also, even if the search is started with the above-mentioned hop-by-hop search or a neighborhood search that will be described later, if a device that has received the search request in the mid point is set to an endpoint search, the searching procedure for the subsequent relaying device is neglected.

Therefore, the searching device 1_3 recognizes that the searching device 1_1 is not an endpoint, and then transmits an ICMP echo request (TTL=2) to the L3 switch 2_2 to verify if the L3 switch 2_2 is the endpoint. As a result, the L3 switch 2_2 returns a response in the same way as mentioned above, so that the searching device 1_3 further executes a procedure for verifying an endpoint in the same way as the above-mentioned step S22.

Step S25: In response thereto, the L3 switch 2_2 returns “Port Unreachable” to a request with respect to an unopened UDP port. Therefore, the searching device 1_3 further transmits a similar ICMP echo request (TTL=3) to the searching device that is the next hop.

In response thereto, the searching device 1_2 returns a response, so that the searching device 1_3 further transmits a message for verifying an endpoint in the same way as mentioned above.

Step S26: The searching device 1_2 having received such a message for verifying the endpoint, is provided with the endpoint interface “End” as shown at the top of FIG. 8, so that the searching device 1_2 knows that it is an endpoint and that the unauthorized access party PC 4_15 exists within its own subnet, so that the searching device 1_2 returns an endpoint response to the searching device 1_3. Also in this case, a single response is returned for a single packet.

Between the searching devices 1_3 and 1_2, a challenge request and a challenge response are made in the same way as shown at steps S13 and S14 of FIG. 6.

Step S27: The searching device 1_3 issues a search request to the searching device 1_2 in the same way as the above-mentioned step S15.

Step S28: In the searching device 1_2, three reception responses are transmitted for a single search request. Requests that have been already accepted/responded are discarded. This is the same as the above-mentioned example.

Thereafter, the searching device 1_2 executes a countermeasure processing since it is an endpoint for the unauthorized access party in the same way as the steps S18 and S19 shown in FIG. 6. When the countermeasure processing is completed, the searching device 1_2 transmits a complete report to the searching device 1_4 which has detected the unauthorized access.

Neighborhood Search Example (Detection by Remote Searching Device):

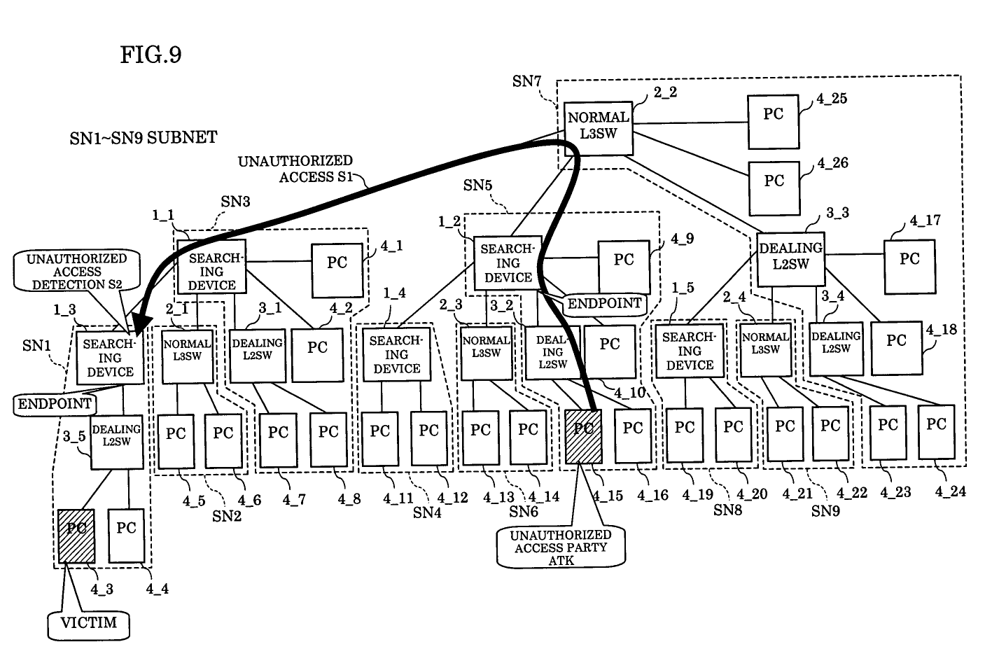

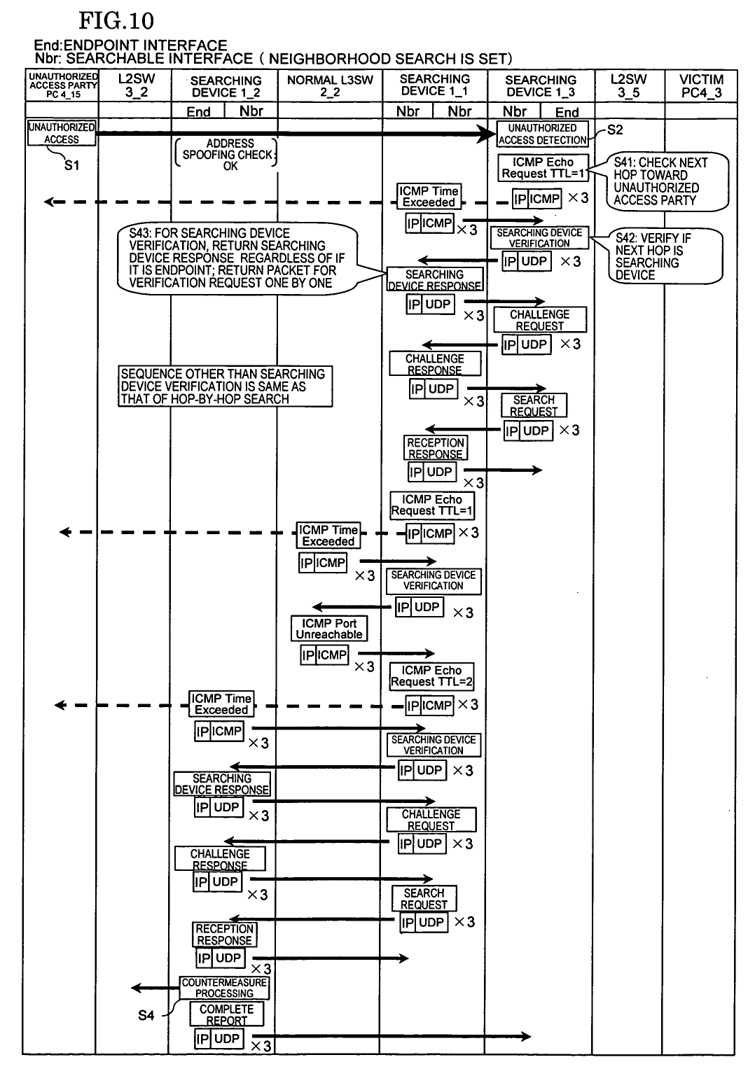

This example is shown in FIG. 9 and the flow of the packet shown in FIG. 9 corresponds to a sequence diagram shown in FIG. 10. Also, the network example of FIG. 9 is the same as that shown in FIG. 7. The sequence of the neighborhood search example will now be described referring to FIGS. 9 and 10.

Firstly, the unauthorized access (at step S1) from the unauthorized access party PC 4_15 is detected (at step S2) by the searching device 1_3 in the same way as in FIG. 8.

Step S41: The searching device 1_3 checks if a next hop exists toward the unauthorized access party in the same way as the above-mentioned step S21. As a result, the searching device 1_1 responds thereto.

Step S42: The searching device 1_3 verifies whether the responded next hop is the searching device 1_1. The message in this case is performed by using the message shown in the above-mentioned Table 6.

Step S43: In response to the message for verifying the searching device from the searching device 1_3, the searching device 1_1 returns a response as a searching device regardless of whether or not the searching device 1_1 itself is an endpoint. In this case, a single packet is returned for a single verification request.

Thus, upon receiving the response that the searching device 1_1 is a searching device, the searching device 1_3 performs an authentication by a challenge request and response in the same way as mentioned above, performs a search request to the searching device 1_1, and then receives an acceptance response from the searching device 1_1.

Thereafter, the searching device 1_1 verifies the next hop and performs a verification of the searching device by finding the existence of the next hop. However, the next hop is a normal L3 switch 2_2, so that the searching device 1_1 is notified that the message returned from the L3 switch 2_2 is an ICMP port unreachable. Therefore, the searching device 1_1 verifies if the searching device 1_2 is the next hop by setting the TTL to 2 for an ICMP echo request.

Between the searching devices 1_1 and 1_2, the searching device verification and response are made, a challenge request and response are further made, and then the searching device 1_1 performs a search request to the searching device 1_2.

Thereafter, in the same way as the steps S18 an S19 shown in FIG. 6, the searching device 1_2 checks the contents of the search request and performs countermeasure processing if it is the unauthorized access requiring a countermeasure to the L2 switch 3_2. When the countermeasure is unnecessary, only the search complete report is transmitted to the searching device 1_3.

It is to be noted that this neighborhood search example is the same as the hop-by-hop search example shown in FIG. 6 except that the searching device verification is performed. However, performing the searching device verification is advantageous in that the searching procedure is not stopped even if there is an intermediate L3 switch, different from the hop-by-hop search example.

Unauthorized Access Detection/Search Example by a Plurality of Searching Devices:

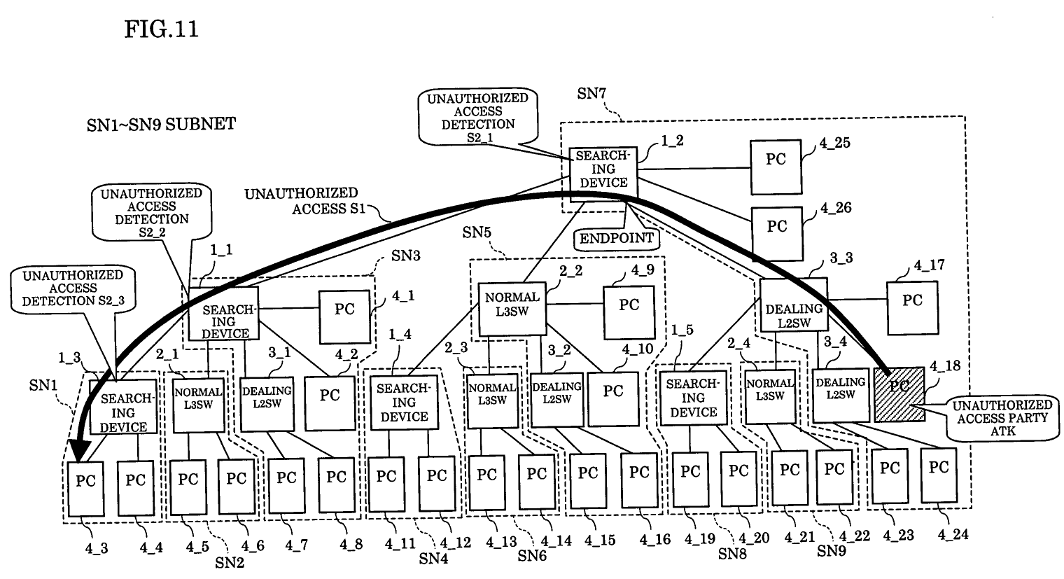

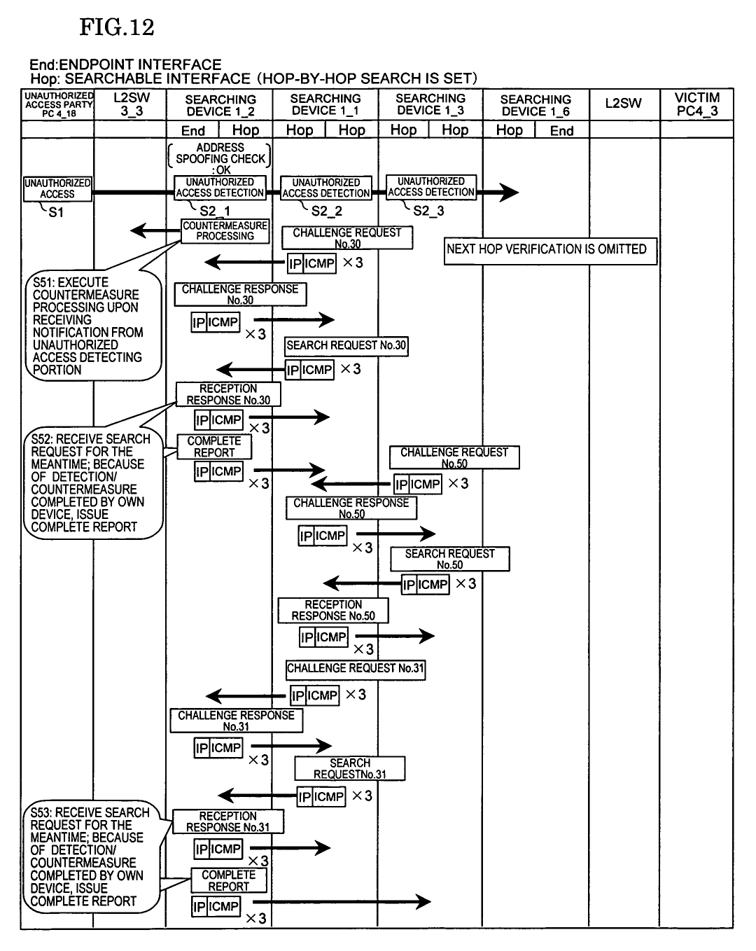

This example is shown in FIG. 11, and the sequence diagram shown in FIG. 12 corresponds to this network example. This example addresses a state where all of the searching devices transmit the search request (when protection stages are provided for an unauthorized access detection, there is a possibility within the time during the protection stage where the unauthorized access packet passes). In this case, whether the “search request” is transferred or issued by the searching device itself is unquestioned. This sequence example will now be described referring to FIGS. 11 and 12.

Firstly, the unauthorized access (at step S1) from the unauthorized access party PC 4_18, having passed through the L2 switch 3_3, undergoes an unauthorized access detection (at steps S2_1, S2_2, S2_3) in all of the searching devices 1_2, 1_1, 1_3. The unauthorized access is then transmitted to the searching device 1_6 that is not shown in FIGS. 11 and 12. It is herein supposed that the searching device 1_6 does not perform an unauthorized access detection.

Each of the searching devices 1_2, 1_1 and 1_3 respectively performs the verification of the next hop. However, for simplification's sake of the drawings, they are omitted from FIGS. 11 and 12.

Step S51: Since the unauthorized access detection is performed by the unauthorized access detecting portion 11, the searching device 1_2 executes the above-mentioned countermeasure processing based on the unauthorized access detection. Therefore, the searching device 1_2 does not perform any further processing voluntarily.

On the other hand, in the example shown in FIG. 12, since the searching device 1_1 performs the unauthorized access detection, after having performed the verification of the next hop and the verification that the next hop is the searching device, the searching device 1_1 performs a challenge request No. 30 and a challenge response No. 30, and transmits a search request No. 30 to the searching device 1_2.

Step S52: While the searching device 1_2 receives the search request No. 30 from the searching device 1_1 for the meantime, the searching device 1_2 has previously detected/performed the countermeasure by the device itself, so that a complete report is issued and transmitted to the searching device 1_1.

On the other hand, since the unauthorized access detection is also performed similarly in the searching device 1_3, a challenge request No. 50 is made to the searching device 1_1 by the searching device 1_3 after performing the verification of the next hop and the verification of the searching device. In response, the searching device 1_1 returns a challenge response No. 50, so that the searching device 1_3 makes a search request No. 50 and the searching device 1_1 returns a search response No. 50 to the searching device 1_3.

Therefore, the searching device 1_1 finishes the processing if the search request is the same as the search request which has been already performed by the searching device 1_1 itself

When any identity between the search request No. 30 and the search request No. 50 cannot be verified, the searching device 1_1 performs a challenge request No. 31 and receives a challenge response No. 31 in the same way as mentioned above to the searching device 1_2, so that a search request No. 31 is further made, thereby responsively receiving an acceptance response No. 31.

Step S53: Also in this case, the search request No. 31 is accepted for the meantime in the same way as the step S52. However, since the searching device 1_2 has already detected and finished the countermeasure, a complete report is issued to the searching device 1_3.

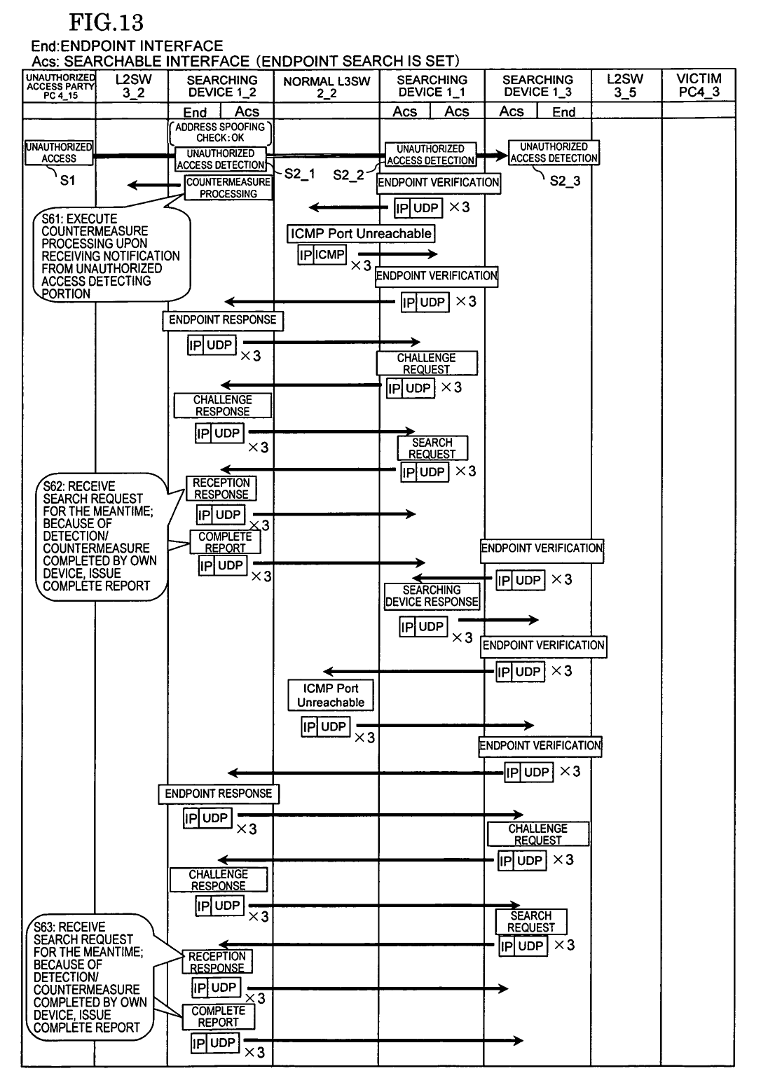

FIG. 13 shows a modification of FIG. 12. While the sequence example of FIG. 12 is of the hop-by-hop system, the case of FIG. 13 is different from FIG. 12 in that the sequence example is of the endpoint search system. The flow procedure of the packet in this case is the same as that shown in FIG. 8.

Namely, the unauthorized access (at step S1) from the unauthorized access party PC 4_15 is detected (at step S2_1) in the searching device 1_2 through the L2 switch 3_2, further detected (at step S2_2) in the searching device 1_1 after having passed through the normal L3 switch 2_2, and further detected (at step S2_3) in the last searching device 1_3.

Step S61: Also in this case, the searching device 1_2 executes a countermeasure processing in the same way as the step S51 in FIG. 12. On the other hand, since the present system is set as an endpoint search system, the searching device 1_1 performs a verification of the endpoint to the L3 switch 2_2 after having performed procedures (not shown) such as next-hop search. In response thereto, the L3 switch 2_2 returns an ICMP port unreachable, so that the searching device 1_1 further performs the endpoint verification to the searching device 1_2, and responsively receives an endpoint response from the searching device 1_2. Therefore, the searching device 1_1 performs a challenge request to the searching device 1_2 and receives a challenge response, so that the searching request is further performed.

Step S62: While the searching device 1_2 accepts the search request for the meantime in the same way as the above-mentioned step S52, the complete report is issued and transmitted to the searching device 1_1 since the searching device 1_2 itself has already completed the detection/countermeasure.

Such a procedure is performed between the searching device 1_3 and the searching device 1_1 in the same way.

Step S63: Therefore, in the searching device 1_2, the search request is accepted for the meantime in the same way as the step S53, and a complete report is transmitted to the searching device 1_3 to the effect that the detection/countermeasure has been already verified.

Sequence Example Upon Time-Out Occurrence:

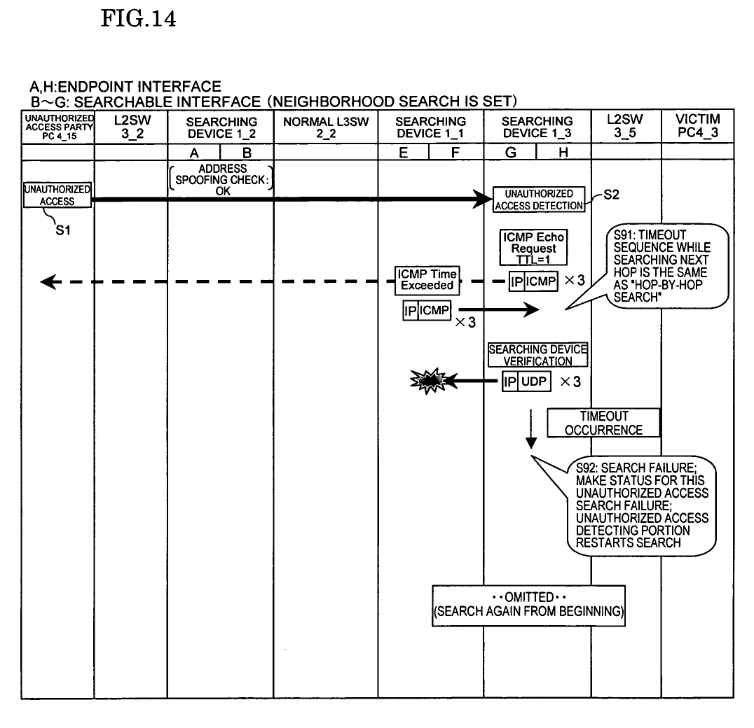

This example is shown in FIG. 14. This is based on a premise, for example, in the packet flowing path shown in FIG. 13, that the unauthorized access is transmitted from the unauthorized access party PC 4_15 to the searching device 1_3 where the unauthorized access detection is performed (at step S2).

Step S91: A procedure for searching the next hop is executed. The sequence at this time is the same as that of the hop-by-hop.

Step S92: Thereafter, the searching device verification is performed, in which if there is no response even after a lapse of a fixed time when a message at this time is transmitted from the searching device 1_2 to the searching device 1_1, it is regarded as a search failure. Also, the search is restarted when the unauthorized access notification is retransmitted.

What is claimed is:

1. An unauthorized access searching method comprising the steps of:
determining whether or not a device itself is designated as a searching device at an endpoint of a subnet accommodating an unauthorized access terminal;
detecting an unauthorized access that has been regarded by the searching device at the endpoint as not having an address spoofed, or receiving a notification of the unauthorized access if the device itself is not designated as the searching device at the endpoint; and
issuing a search request including an address of the unauthorized access terminal towards the searching device at the endpoint when the unauthorized access is detected or the notification is received.

2. The unauthorized access searching method as claimed in claim 1, further comprising the step of processing countermeasures to a switch in a lower layer accommodating the unauthorized access terminal included in the search request when the device itself is designated as the searching device at the endpoint and the search request is received.

3. The unauthorized access searching method as claimed in claim 1, further comprising the step of issuing the search request to a searching device of a next hop when the device itself is not designated as the endpoint and the search request is received.

4. The unauthorized access searching method as claimed in claim 1, further comprising the step of having the searching device which has initiated issuing the search request perform the search request sequentially to a searching device of an intermediate hop between the searching devices on both ends until the searching device at the endpoint is verified.

5. The unauthorized access searching method as claimed in claim 3, further comprising the step of verifying whether or not the next hop, as a first next hop, is a searching device provided with a searching function before issuing the search request to the searching device of the first next hop, and further verifying whether or not a subsequent next hop is a searching device if the first next hop is not a searching device.

6. The unauthorized access searching method as claimed in claim 1, further comprising the step of notifying a detection completion to the searching device that has issued the search request when a search request for a same unauthorized access is received from another searching device having detected the unauthorized access.

7. The unauthorized access searching method as claimed in claim 1, wherein the searching device at the endpoint discards a packet whose address is spoofed when the packet is detected.

8. The unauthorized access searching method as claimed in claim 1, wherein the searching device includes a searching device without a function of detecting the unauthorized access.

9. The unauthorized access searching method as claimed in claim 3, further comprising the step of issuing the search request after having executed an authentication procedure for the next hop when an existence of the next hop is verified.

10. The unauthorized access searching method as claimed in claim 2, wherein the countermeasure processing step includes a step of setting a filter by a telnet.

11. The unauthorized access searching method as claimed in claim 10, further comprising the step of releasing the filter setting after a lapse of a fixed time after the filter setting.

12. An unauthorized access searching device comprising:
means determining whether or not the device itself is designated as a searching device at an endpoint of a subnet accommodating an unauthorized access terminal;
means detecting an unauthorized access that has been regarded by the searching device at the endpoint as not having an address spoofed, or receiving a notification of the unauthorized access if the device itself is not designated as the searching device at the endpoint; and
means issuing a search request including an address of the unauthorized access terminal towards the searching device at the endpoint when the unauthorized access is detected or the notification is received.

13. The unauthorized access searching device as claimed in claim 12, further comprising means processing countermeasures to a switch in a lower layer accommodating the unauthorized access terminal included in the search request when the device itself is designated as the searching device at the endpoint and the search request is received.

14. The unauthorized access searching device as claimed in claim 12, further comprising means issuing the search request to a searching device of a next hop when the device itself is not designated as the endpoint and the search request is received.

15. The unauthorized access searching device as claimed in claim 12, further comprising means having the searching device which has initiated issuing the search request perform the search request sequentially to a searching device of an intermediate hop between the searching devices on both ends until the searching device at the endpoint is verified.

16. The unauthorized access searching device as claimed in claim 14, further comprising means verifying whether or not the next hop, as a first next hop, is a searching device provided with a searching function before issuing the search request to the searching device of the first next hop, and further verifying whether or not a subsequent next hop is a searching device if the first next hop is not a searching device.

17. The unauthorized access searching device as claimed in claim 12, further comprising means notifying a detection completion to the searching device that has issued the search request when a search request for a same unauthorized access is received from another searching device having detected the unauthorized access.

18. The unauthorized access searching device as claimed in claim 12, wherein the searching device at the endpoint discards a packet whose address is spoofed when the packet is detected.

19. The unauthorized access searching device as claimed in claim 12, wherein the searching device includes a searching device without a function of detecting the unauthorized access.

20. The unauthorized access searching device as claimed in claim 14, further comprising means issuing the search request after having executed an authentication procedure for the next hop when an existence of the next hop is verified.

21. The unauthorized access searching device as claimed in claim 13, wherein the countermeasure processing means includes means setting a filter by a telnet.

22. The unauthorized access searching device as claimed in claim 21, further comprising means releasing the filter setting after a lapse of a fixed time after the filter setting.
